(19) United States
(12) Patent Application Publication
(10) Pub. No.: US 2025/0371555 A1
(43) Pub. Date: Dec. 4, 2025

(54) CROP CARBON FOOTPRINT EVALUATION METHOD AND SYSTEM, DEVICE, AND STORAGE MEDIUM

(71) Applicants: Institute of Soil Science, Chinese Academy of Sciences, Nanjing City (CN); Ningbo University, Ningbo City (CN)

(72) Inventors: Guangbin ZHANG, Nanjing City (CN); Xiaoyuan YAN, Nanjing City (CN); Jing MA, Nanjing City (CN); XU Hua, Nanjing City (CN); Zhenke ZHU, Nanjing City (CN); Tida GE, Nanjing City (CN)

(73) Assignees: Institute of Soil Science, Chinese Academy of Sciences, Nanjing City (CN); Ningbo University, Ningbo City (CN)

(21) Appl. No.: 18/817,717

(22) Filed: Aug. 28, 2024

(30) Foreign Application Priority Data
May 28, 2024 (CN) 202410667547.0

(51) Int. Cl. G06Q 30/018; G06Q 50/02

(52) U.S. Cl. CPC G06Q 30/018; G06Q 50/02

(57) ABSTRACT

A crop carbon footprint evaluation method including: acquiring historical data of crops to be evaluated at a production stage and a planting stage; determining a first carbon emission, a second carbon emission, and a third carbon emission of the crops to be evaluated per unit planting area based on the historical data; determining a first adjustment factor and a second adjustment factor by predicting a carbon emission characteristic model; acquiring a planting area of the crops to be evaluated, and determining a first total carbon emission of seeds of the crops to be evaluated based on the planting area, the first carbon emission, the second carbon emission, the first adjustment factor and the second adjustment factor; determining a second total carbon emission after the crops to be evaluated grow; determining a target strategy for reducing carbon footprint for the crops to be evaluated.

### INCORPORATION BY REFERENCE

This application claims priority to China Patent Application No. 202410667547.0 filed May 28, 2024, the contents of which are hereby incorporated by reference in their entirety.

### TECHNICAL FIELD

The present disclosure relates to the technical field of carbon emission, and more particularly to a crop carbon footprint evaluation method and system, a device, and a storage medium.

### BACKGROUND

Nowadays, field trial methods are commonly used to directly monitor greenhouse gas (GHG) emissions from crops and the variation in Soil Organic Carbon (SOC) to evaluate the carbon footprint and carbon sequestration potential of crops. According to the evaluation method, more accurate greenhouse gas emission data and a change trend of soil organic carbon can be acquired by setting monitoring apparatuses in the farmland of crops for real-time monitoring. Chinese patents of rice carbon footprint evaluation method and system, electronic device, and storage medium (publication No. CN115719184 A) and greenhouse gas net emission estimating method and apparatus, device, and storage medium (publication No. CN116681315A) both disclose corresponding carbon footprint evaluation methods.

However, this evaluation method requires a lot of manpower and material resources, and has some disadvantages, such as smaller monitoring area, smaller coverage, fewer monitoring points and shorter monitoring period. Therefore, the existing evaluation methods are difficult to accurately and efficiently reflect the true carbon footprint characteristics of crops, and there are some limitations, and it is even impossible to develop relevant strategies to reduce carbon footprint for crops.

### SUMMARY

Aiming at the technical problems in the prior art, the present disclosure provides a crop carbon footprint evaluation method and system capable of performing carbon footprint evaluation and carbon footprint reduction on crops in a rapid, accurate and cost-effective manner, a device, and a storage medium.

The technical solution of the present disclosure for solving the above technical problem is as follows:
the present disclosure provides a crop carbon footprint evaluation method, including:
acquiring historical data of crops to be evaluated at a production stage and a planting stage;
determining, based on the historical data, a first carbon emission consumed energy in the planting stage, a second carbon emission consumed energy in the fertilizing stage, and a third carbon emission in the growing stage of the crops to be evaluated per unit planting area;
determining a first adjustment factor and a second adjustment factor of the carbon emission of the crops to be evaluated affected by other factors by predicting the carbon emission characteristic model in combination with the historical data;
acquiring a planting area of the crops to be evaluated, and determining a first total carbon emission of seeds of the crops to be evaluated based on the planting area, the first carbon emission, the second carbon emission, the first adjustment factor and the second adjustment factor, including: processing the first adjustment factor and the second adjustment factor to obtain a corresponding percentage value; treating the first carbon emission and the second carbon emission according to their degree of effect on the first total carbon emission to obtain treated first carbon emission and treated second carbon emission; determining the first total carbon emission based on the planting area, the treated first carbon emission, the treated second carbon emission, and the percentage value; where the first total carbon emission is represented as:

$$C = ( {E}^{2} + \sqrt{F} ) \times A \times {( 1 + \frac{T}{100} )}^{2} \times {( 1 + \frac{S}{100} )}^{2} ;$$

where C is the first total carbon emission, E is the first carbon emission, F is the second carbon emission, A is the planting area, T is the first adjustment factor, and S is the second adjustment factor;
determining a second total carbon emission after the crops to be evaluated grow, based on the first total carbon emission and the third carbon emission; and
determining a target strategy for reducing carbon footprint for the crops to be evaluated based on the second total carbon emission.

Alternatively, the determining, based on the historical data, a first carbon emission consumed energy in the planting stage, a second carbon emission consumed energy in the fertilizing stage, and a third carbon emission in the growing stage of the crops to be evaluated per unit planting area includes:
predicting the first carbon emission based on a planting density, a growth cycle, a planting device used, and an energy type of the crops to be evaluated in the historical data;
predicting the second carbon emission based on the amount, number and manner of fertilization of the crops to be evaluated in the historical data; and
predicting the third carbon emission based on the historical data of soil, water resources, pesticide use data of the growing stage of the crops to be evaluated, and soil carbon sequestration emission data of the area where the crops to be evaluated are located.

Alternatively, the determining a first adjustment factor and a second adjustment factor of the carbon emission of the crops to be evaluated affected by other factors by predicting the carbon emission characteristic model in combination with the historical data includes:
performing first feature extraction on the historical data through the carbon emission characteristic model to obtain first features related to soil management and pesticide use of the crops to be evaluated;
performing second feature extraction on the historical data through the carbon emission characteristic model to obtain second features related to the transportation of the crops to be evaluated; and
processing the first characteristic through the carbon emission characteristic model to output the first adjustment factor, and processing the second characteristic to output the second adjustment factor.

Alternatively, the determining a second total carbon emission after the crops to be evaluated grow, based on the first total carbon emission and the third carbon emission includes:
acquiring a processed first adjustment factor;
treating the third carbon emission according to its degree of effect on the second carbon emission to obtain a treated third carbon emission;
determining the second total carbon emission based on the first total carbon emission, the treated first adjustment factor, and the treated third carbon emission, where the second total carbon emission is represented as:

$$P = {( C \times {( 1 + \frac{T}{100} )}^{2} )}^{2} + \sqrt{B} \times ( 1 + \frac{T}{100} ) ;$$

where P is the second total carbon emission, C is the first total carbon emission, T is the first adjustment factor, and B is the third carbon emission.

Alternatively, the determining a target strategy for reducing carbon footprint for the crops to be evaluated based on the second total carbon emission includes:
determining carbon emission constituent data for each link of the crops to be evaluated based on the second total carbon emission;
determining a target emission reduction for the carbon footprint of the crops to be evaluated based on the carbon emission constituent data; and
specifying the target strategy based on the target emission reduction.

Alternatively, the acquiring historical data of crops to be evaluated at a production stage and a planting stage includes:
determining a data source of the historical data, where the data source comprise planting record reports and environmental monitoring reports of the planting area of the crops to be evaluated;
acquiring first historical data of the planting stage from the data source; where the first historical data includes a planting density, an area, growth cycle data, first energy consumption data, greenhouse gas emission data and soil organic carbon content data of the crops to be evaluated; and
acquiring second historical data of the growing stage from the data source; the second historical data includes fertilization data, second energy consumption data, and water resources, soil, and pesticide use data.

The present disclosure also provides a crop carbon footprint evaluation system, including:
a data acquisition module, configured to acquire historical data of the crops to be evaluated at a production stage and a planting stage;
an intermediate data module, configured to determine, based on the historical data, a first carbon emission consumed energy in the planting stage, a second carbon emission consumed energy in the fertilizing stage, and a third carbon emission in the growing stage of the crops to be evaluated per unit planting area;
a factor determining module, configured to determine a first adjustment factor and a second adjustment factor of the carbon emission of the crops to be evaluated affected by other factors by predicting the carbon emission characteristic model in combination with the historical data;
a first calculation module, configured to acquire a planting area of the crops to be evaluated, and determine a first total carbon emission of seeds of the crops to be evaluated based on the planting area, the first carbon emission, the second carbon emission, the first adjustment factor and the second adjustment factor; the first calculation module is further configured to process the first adjustment factor and the second adjustment factor to obtain a corresponding percentage value, treat the first carbon emission and the second carbon emission according to the degree of their degree of effect on the first total carbon emission to obtain treated first carbon emission and treated second carbon emission, determine the first total carbon emission based on the planting area, the treated first carbon emission, the treated second carbon emission, and the percentage value; where the first total carbon emission as: is represented

$$C = ( {E}^{2} + \sqrt{F} ) \times A \times {( 1 + \frac{T}{100} )}^{2} \times {( 1 + \frac{S}{100} )}^{2} ;$$

where C is the first total carbon emission, E is the first carbon emission, F is the second carbon emission, A is the planting area, T is the first adjustment factor, and S is the second adjustment factor;
a second calculation module, configured to determine a second total carbon emission after the crops to be evaluated grow, based on the first total carbon emission and the third carbon emission; and
a strategy determining module, configured to determine a target strategy for reducing carbon footprint for the crops to be evaluated based on the second total carbon emission.

Moreover, to achieve the above object, the present disclosure also provides a device, including: a memory for storing a computer software program; a processor for reading and executing the computer software program to implement a crop carbon footprint evaluation method as described above.

Moreover, to achieve the above object, the present disclosure also provides a storage medium having a computer software program stored therein, when executed by a processor, the computer software program implementing the crop carbon footprint evaluation method as described above.

Advantageous effects of the present disclosure are as follows:
(1) The present disclosure can rapidly and effectively predict carbon emission data of a crop at various stages based on historical data of the crop at the planting stage and the growing stage, and further accurately predict the total carbon emission of the crop after future planting and growing by considering the effect of the predicted carbon emission data on the total carbon emission data, thereby not only improving the efficiency and accuracy of crop carbon footprint evaluation in a low cost manner, but also developing a target strategy for reducing the carbon footprint based on the accurate carbon footprint data.
(2) The present disclosure can effectively reduce the carbon emission of crops and reduce the negative effect on the environment by carrying out quantitative analysis and evaluation on carbon emission during the cultivation, production and transportation of crops and formulating targeted emission reduction strategies and measures in combination with adjustment factors and carbon footprint evaluation models.
(3) The present disclosure helps to improve resource utilization efficiency, reduce resource waste, and reduce energy consumption and carbon emission during production and achieve sustainable development by optimizing strategies for energy, water resources, soil, and fertilization management.
(4) By reducing the carbon footprint and optimizing the production process, the present disclosure can improve the quality and brand image of agricultural products, increase the added value and competitiveness of agricultural products, and meet consumers' demands for environmental protection and health.

### BRIEF DESCRIPTION OF DRAWINGS

FIG. 1 is a scene diagram of a crop carbon footprint evaluation method provided by the present disclosure;

FIG. 2 is a flow chart of a crop carbon footprint evaluation method provided by the present disclosure;

FIG. 3 is a schematic structural diagram of a crop carbon footprint evaluation system provided by the present disclosure;

FIG. 4 is a schematic structural diagram showing hardware of one possible device provided by the present disclosure;

FIG. 5 is a schematic structural diagram of the hardware of one possible computer-readable storage medium provided by the present disclosure.

### DETAILED DESCRIPTION OF EMBODIMENTS

The embodiments of the present disclosure will now be described more fully hereinafter with reference to the accompanying drawings, in which embodiments of the present disclosure are shown. It is to be understood that the embodiments described are only a few, but not all embodiments of the present disclosure. Based on the embodiments of the present application, all other embodiments obtained by a person skill in the art without inventive effort fall within the scope of the present application.

In the description of the present disclosure, the terms “first” and “second” are used for descriptive purposes only and are not to be construed as indicating or implying relative importance or implicitly indicating the number of technical features indicated. Thus, a feature defined as “first” or “second” may explicitly or implicitly comprise one or more of the feature. In the description of the present disclosure, “a plurality of” refers to two or more unless specifically defined otherwise.

In the description of the present disclosure, the term “for example” is used to mean “serving as an example, instance, or illustration”. Any embodiment described herein as “for example” is not necessarily to be construed as preferred or advantageous over other embodiments. The following description is presented to enable any person skilled in the art to make and use the present disclosure. In the following description, details are set forth for purposes of explanation. It will be understood by a person skilled in the art that the present disclosure may be practiced without these specific details. In other instances, well-known structures and processes have not been described in detail so as not to obscure the description of the present disclosure with unnecessary detail. Thus, the present disclosure is not intended to be limited to the embodiments shown, but is to be accorded the widest scope consistent with the principles and features disclosed herein.

Referring to FIG. 1, FIG. 1 is a scene diagram of a crop carbon footprint evaluation method provided by the present disclosure. As shown in FIG. 1, the terminal and the server are connected through a network, for example, a wired or wireless network connection, etc. The terminals may include, but are not limited to, a portable terminal such as a mobile phone and a tablet installed with various network platform applications, and a fixed terminal such as a computer, an inquiry machine and an advertisement machine. The server provides various service services for the user, including a service pushing server, a user recommendation server, etc.

It should be noted that the scene diagram of a crop carbon footprint evaluation method shown in FIG. 1 is merely an example, and the terminal, the server, and the application scene described in the embodiment of the present disclosure are for more clearly illustrating the technical solution of the embodiment of the present disclosure, and do not generate a limitation on the technical solution provided by the embodiment of the present disclosure; and it would have been obvious for a person skilled in the art that the technical solution provided by the embodiment of the present disclosure is also applicable to similar technical problems as the system evolves and new business scenes appear.

The terminal may be configured to:
acquire historical data of crops to be evaluated at a production stage and a planting stage;
determine, based on the historical data, a first carbon emission consumed energy in the planting stage, a second carbon emission consumed energy in the fertilizing stage, and a third carbon emission in the growing stage of the crops to be evaluated per unit planting area;
determine a first adjustment factor and a second adjustment factor of the carbon emission of the crops to be evaluated affected by other factors by predicting the carbon emission characteristic model in combination with the historical data; acquire a planting area of the crops to be evaluated, and determine a first total carbon emission of seeds of the crops to be evaluated based on the planting area, the first carbon emission, the second carbon emission, the first adjustment factor and the second adjustment factor, including: process the first adjustment factor and the second adjustment factor to obtain a corresponding percentage value; treat the first carbon emission and the second carbon emission according to their degree of effect on the first total carbon emission to obtain treated first carbon emission and treated second carbon emission; determine the first total carbon emission based on the planting area, the treated first carbon emission, the treated second carbon emission, and the percentage value; where the first total carbon emission is represented as:

$$C = ( {E}^{2} + \sqrt{F} ) \times A \times {( 1 + \frac{T}{100} )}^{2} \times {( 1 + \frac{S}{100} )}^{2} ;$$

where C is the first total carbon emission, E is the first carbon emission, F is the second carbon emission, A is the planting area, T is the first adjustment factor, and S is the second adjustment factor;
determine a second total carbon emission after the crops to be evaluated grow, based on the first total carbon emission and the third carbon emission; and
determine a target strategy for reducing carbon footprint for the crops to be evaluated based on the second total carbon emission.

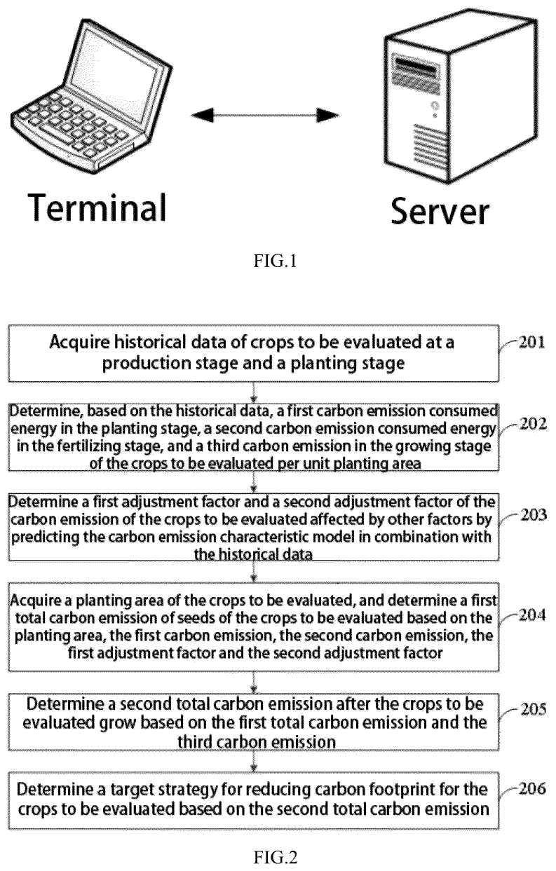

Referring to FIG. 2, FIG. 2 provides a flow chart of a crop carbon footprint evaluation method of the present disclosure, the method including the steps of:
step 201: historical data of crops to be evaluated is acquired at a production stage and a planting stage;

In some embodiments, step 201 may include:
a data source of the historical data is determined, where the data source comprise planting record reports and environmental monitoring reports of the planting area of the crops to be evaluated;
first historical data of the planting stage is acquired from the data source; where the first historical data includes a planting density, an area, a growth cycle data, first energy consumption data, greenhouse gas emission data, and soil organic carbon content data of the crops to be evaluated; and
second historical data of the growing stage is acquired from the data source; the second historical data includes fertilization data, second energy consumption data, and water resources, soil, and pesticide use data.

In some embodiments, planting record reports may be acquired from a planting area or farm management, and may include, for example, the planting density, the planting area, the growth cycle of the planted crop, etc. which are typically recorded and reported by a farm or planting base as one of the sources of the first historical data of the planting stage.

In some embodiments, an environmental monitoring report issued by an environmental monitoring department or related agency may be acquired, including data related to agricultural production, such as greenhouse gas emission data, soil quality, water resources utilization, etc. It will be appreciated that environmental monitoring reports are used to provide quantitative and qualitative data on the environmental conditions of the planting area and provide an important reference for evaluating the growing stage of crops.

In some embodiments, crop planting density and planting area data may be obtained from a planting record report. For example, the growth cycle of a crop can be recorded, including the time and information of the critical stages of sowing, growing, harvesting, etc. The data of the amount of energy consumed during planting, such as the amount of water, electricity, fuel, etc. can be acquired from the energy consumption records of a farm or planting base. Environmental monitoring reports or relevant data collection can be used to obtain greenhouse gas emission data generated during planting, which can be calculated according to energy consumption and emission coefficient.

In some embodiments, the data on the amount, number and manner of fertilization, etc. may be acquired from farm records or fertilization records. The data of the energy consumed during the growing stage can be recorded, such as the energy consumption of the agricultural machine, the energy consumption of the irrigation system, etc. The data of irrigation amount, water resources, soil management, the amount of pesticide usage and the use frequency can be collected to analyze and calculate the carbon emission effect in the growing stage.

Through the above methods, it is helpful to comprehensively understand the energy consumption and carbon emission of the crops to be evaluated in the planting stage and the growing stage, and provide data support for developing carbon footprint evaluation and emission reduction strategies.

Step 202, based on the historical data, a first carbon emission consumed energy in the planting stage, a second carbon emission consumed energy in the fertilizing stage, and a third carbon emission in the growing stage of the crops to be evaluated per unit planting area are determined.

In some embodiments, step 202 may include:
the first carbon emission is predicted based on the planting density, the growth cycle, a planting device used, and an energy type of the crops to be evaluated in the historical data;
the second carbon emission is predicted based on the amount, number and manner of fertilization of the crops to be evaluated in the historical data; and
the third carbon emission is predicted based on the historical data of soil, water resources, pesticide use data of the growing stage of the crops to be evaluated, and soil carbon sequestration emission data of the area where the crops to be evaluated are located.

The planting density reflects the number of crops per unit area, which affects the utilization of energy and water resources, and the duration of the growth cycle is directly related to the crop demand for energy and water resources.

It will be appreciated that carbon emission can be affected by the amount of energy consumed by different planting devices and energy types. The present disclosure, by taking the above factors into consideration, can establish a model to predict carbon emission at the planting stage using a statistical method or a machine learning algorithm. For example, carbon emission per unit area or per unit yield may be calculated based on planting density, growth cycle and energy consumption records in the historical data.

The amount, number and manner of fertilization (such as fertilizer types, fertilization tools) in the process of fertilization have an effect on the production of greenhouse gases in soil. Based on historical fertilization records and related data, a model can be established to predict carbon emission during growing stage. For example, the carbon emissions in the process of fertilization are calculated by the factors of the amount, number and manner of fertilization combined with the corresponding emission coefficient or model.

Soil carbon sequestration refers to a process in which organic carbon in soil is fixed or stored and no longer released into the atmosphere. The process mainly includes the decomposition of plant residues, the contribution of root exudates, microorganism metabolism and colloidal structure and other factors, and stable storage of organic carbon in soil is an important performance of soil carbon sequestration.

In some embodiments, based on knowledge of soil carbon sequestration, the soil carbon sequestration emission at the growing stage of the crops to be evaluated can be predicted by establishing a carbon flow model or using an existing soil carbon cycle model. This requires consideration of the source of organic carbon in the soil, decomposition rate, stability, and interaction with plant roots, microorganisms, colloidal structures, etc.

In some embodiments, increases and decreases in soil carbon sequestration may be considered when predicting third carbon emission, for example, factors including organic carbon input (e.g., plant residues, root exudates), organic carbon decomposition rate, soil flux, etc. At the same time, the effects of soil moisture, temperature and oxygen level on the decomposition and release of soil organic carbon, and the effects of crop planting density, species and fertilization on soil carbon sequestration can also be considered.

In some embodiments, the third carbon emission may be predicted by establishing a machine learning algorithm or predicting soil carbon sequestration emissions using a machine learning algorithm, incorporating soil characteristics, crop growth and environmental factors from historical data into the model. It will be appreciated that the established model may take into account complex relationships between variables to accurately predict soil carbon sequestration emissions.

Soil management, water resources utilization, and pesticide use will affect carbon cycle in soil and water bodies, thereby affecting gas emissions. According to the historical data of soil management, water resources utilization and pesticide use, the carbon emission at the growing stage can be predicted. For example, through the analysis of soil quality, water resources utilization efficiency and pesticide usage, combined with the corresponding models or calculation methods, carbon emissions at the growing stage are estimated.

In this way, the present disclosure can use the historical data and relevant parameters of historical planting and growth of the crop comprehensively, and in combination with suitable models and algorithms, can more accurately predict the carbon emission of the crops to be evaluated in the planting stage and growing stage to provide a scientific basis for formulating emission reduction strategies and evaluating carbon footprint. Such predictions and analyses also help to optimize agricultural production processes, reduce carbon emission, and promote sustainable agricultural development.

Step 203, a first adjustment factor and a second adjustment factor of the carbon emission of the crops to be evaluated affected by other factors are determined by predicting the carbon emission characteristic model in combination with the historical data.

In some embodiments, step 203 may include:
first feature extraction is performed on the historical data through the carbon emission characteristic model to obtain first features related to soil management and pesticide use of the crops to be evaluated;
second feature extraction is performed on the historical data through the carbon emission characteristic model to obtain second features related to the transportation of the crops to be evaluated; and
the first characteristic is processed through the carbon emission characteristic model to output the first adjustment factor, and processing the second characteristic to output the second adjustment factor.

The first adjustment factor and the second adjustment factor are both constant values which are greater than 1 and less than 100, such as 10 and 20 output by the model after feature processing.

In some embodiments, the historical data may be analyzed and processed through a carbon emission characteristic model to extract a first characteristic relating to soil management and pesticide use of the crops to be evaluated, e.g. the first characteristic may include soil management, fertilization amount, pesticide usage and frequencies, etc. For example, machine learning algorithms or statistical models can be used to extract features from soil management and pesticide use data in the historical data to derive key factors that affect carbon emission.

In some embodiments, the historical data may be analyzed and processed through a carbon emission characteristic model to extract a second characteristic related to the transportation of the crops to be evaluated, e.g. the second characteristic may include factors closely related to carbon emission such as transportation distance, means of transport, transportation means, etc. For example, data related to transportation processes of the crop may be extracted from historical data, and key features of the transportation stage may be extracted in conjunction with information such as transportation distance and means of transport type.

The data extracted for the first feature and the second feature may be further processed and analyzed to output a first adjustment factor and a second adjustment factor. The first adjustment factor relates to the degree of effect of soil management and pesticide use on carbon emission, and may reflect the extent to which these factors contribute to total carbon emission based on adjustment coefficients or ratios related to the output of the model. The second adjustment factor relates to the degree of effect of transportation process on carbon emission, and the corresponding adjustment coefficient or proportion is output according to the model to reflect the degree of effect of transportation stage on total carbon emission.

Through the above steps, the key features can be extracted from the historical data by using the carbon emission characteristic model, and further processed to obtain the adjustment factors to more accurately evaluate the carbon emission of the crops to be evaluated at different stages, and provide a scientific basis for formulating emission reduction strategies. The above methods based on feature extraction and adjustment factor analysis are helpful to understand the formation mechanism of carbon emission and guide the low-carbon measures for agricultural production and environmental protection.

Step 204, a planting area of the crops to be evaluated is acquired, and a first total carbon emission of seeds of the crops to be evaluated is determined based on the planting area, the first carbon emission, the second carbon emission, the first adjustment factor, and the second adjustment factor.

In some embodiments, step 204 may include:
the first adjustment factor and the second adjustment factor are processed to obtain a corresponding percentage value;
the first carbon emission and the second carbon emission are treated according to their degree of effect on the first total carbon emission to obtain treated first carbon emission and treated second carbon emission;
the first total carbon emission is determined based on the planting area, the treated first carbon emission, the treated second carbon emission, and the percentage value.

In some embodiments, the first total carbon emission is represented as:

$$C = ( {E}^{2} + \sqrt{F} ) \times A \times {( 1 + \frac{T}{100} )}^{2} \times {( 1 + \frac{S}{100} )}^{2} ;$$

where C is the first total carbon emission, E is the first carbon emission, F is the second carbon emission, A is the planting area, T is the first adjustment factor, and S is the second adjustment factor.

In the specific implementation, E is the carbon emission generated by the amount of energy consumed in the process of planting crops; F is the carbon emission produced by crops in the process of fertilization; A is the planting area of the crop; T is the first adjustment factor of carbon emission caused by soil management and pesticide use factors; S is the second adjustment factor for carbon emission caused by the transportation stage of the crop.

The values of T and S are greater than 1 and less than 100, and thus can be converted to a percentage value by dividing by the constant 100.

It will be appreciated that the present disclosure, in predicting the first total carbon emission, the first carbon emission E is not simply overlapped with the second carbon emission F, but their respective effect on the first total carbon emission is considered. For example, the carbon emission generated by the amount of energy consumed in the process of generally greater than the effect and contribution of the carbon emission generated by the crop in the process of fertilization on the total carbon emission, therefore, E² is equivalent to considering the effect of enlarging the first carbon emission in calculating the first total carbon emission, and \sqrt{F} is equivalent to considering the effect of reducing the second carbon emission in calculating the first total carbon emission.

To sum up, the formula for calculating the first total carbon emission takes into account the energy consumption of crops in the process of planting, the carbon emission in the process of fertilization, the planting area and the effects of other factors on the total carbon emission in the process of soil management and transportation of the crop to estimate the total carbon emission of seeds of a crop.

Step 205, a second total carbon emission after the crops to be evaluated grow is determined based on the first total carbon emission and the third carbon emission.

In some embodiments, step 205 may include:
a processed first adjustment factor is acquired;
the third carbon emission is treated according to its degree of effect on the second carbon emission to obtain a treated third carbon emission;
the second total carbon emission is determined based on the first total carbon emission, the treated first adjustment factor, and the treated third carbon emission.

In some embodiments, the second total carbon emission is represented as:

$$P = {( C \times {( 1 + \frac{T}{100} )}^{2} )}^{2} + \sqrt{B} \times ( 1 + \frac{T}{100} ) ;$$

where P is the second total carbon emission, C is the first total carbon emission, T is the first adjustment factor, and B is the third carbon emission.

In the specific implementation, P represents the carbon emission after crop growth; C represents the total carbon emission of seeds of a crop; T is an adjustment factor representing the effect of soil management and pesticide use on carbon emission; B represents the amount of additional carbon emission during crop growth, assuming it is a constant.

$${( C \times {( 1 + \frac{T}{100} )}^{2} )}^{2}$$

represents that the above adjusted values are squared to highlight their importance in total carbon emission.

$$\sqrt{B} \times ( 1 + \frac{T}{100} )$$

represents the effect of adding an additional carbon emission related to the adjustment factor T to the total carbon emission, assuming that this additional carbon emission is the square root of a constant B, while adjustment is performed according to the adjustment factor T.

It will be appreciated that by the same reasoning as for \sqrt{F}, \sqrt{B} is a processing operation performed to consider the third carbon emission B having a smaller degree of effect on the second total carbon emission calculation, which can improve the accuracy of predicting the crop carbon footprint.

Step 206, a target strategy for reducing carbon footprint for the crops to be evaluated is determined based on the second total carbon emission.

In some embodiments, step 206 may include:
carbon emission constituent data for each link of the crops to be evaluated is determined based on the second total carbon emission;
a target emission reduction for the carbon footprint of the crops to be evaluated is determined based on the carbon emission constituent data; and
the target strategy is specified based on the target emission reduction.

In some embodiments, based on the second total carbon emission, the carbon emission of the crops to be evaluated at various stages may be decomposed and analyzed to obtain carbon emission constituent data. For example, these links may include a planting stage, a fertilizing stage, a growing stage, and a transportation stage, etc.

In some embodiments, the contribution degree of each link to the total carbon emission can be quantitatively determined by combining historical data and information obtained by feature extraction with a carbon emission characteristic model, and carbon emission constituent data of each link can be obtained.

In some embodiments, a target emission reduction for a carbon footprint of the crops to be evaluated are set based on an analysis of carbon emission constituent data. The target emission reduction may be an emission reduction ratio or value with respect to historical data or industry standards. By setting reasonable emission reduction targets, agricultural production can be promoted to the direction of low-carbon, environmental protection and sustainable agricultural development.

In some embodiments, based on the determined target amount of emission reduction, corresponding target strategies and measures are formulated, including technical innovation, management optimization, resource saving and energy consumption reduction measures. For example, in the planting stage, water-saving irrigation technology can be promoted, and fertilization program can be optimized to reduce fertilizer use; renewable energy can be used to replace traditional energy in the growing stage to reduce energy consumption in the production process; transportation routes and means of transport can be optimized during the transportation stage to reduce energy consumption and carbon emission during transportation.

By way of example only, one target strategy may include: (1) promoting the use of organic fertilizer and reducing the use of fertilizer; optimizing the planting device and the irrigation system to reduce energy consumption; and implementing precise agricultural management to reduce pesticide usage and greenhouse gas emissions. (2) Adopting precise fertilization technology to reduce the fertilization amount and frequency; promoting the use of organic fertilizer, reducing the emission of active nitrogen, improving soil quality and promoting soil carbon sequestration. (3) Using an energy-saving irrigation system to reduce water resources consumption and energy consumption and reduce methane emissions; promoting agro-ecological environment-friendly technology to reduce pesticide usage and soil erosion. (4) Optimizing transportation routes and means of transport to reduce transportation distances and energy consumption; and encouraging the use of low-carbon transportation modes, such as changing from road transportation to rail transportation.

Through the above methods, it is possible to comprehensively understand the carbon emission of the crops to be evaluated, and formulate specific emission reduction targets and strategies to realize the effective reduction of carbon footprint and promote the sustainable development of agricultural production and environmental protection. This method based on data analysis and emission reduction strategy is helpful to guide agricultural production practice, improve resource utilization efficiency, reduce environmental pollution and promote green low-carbon development.

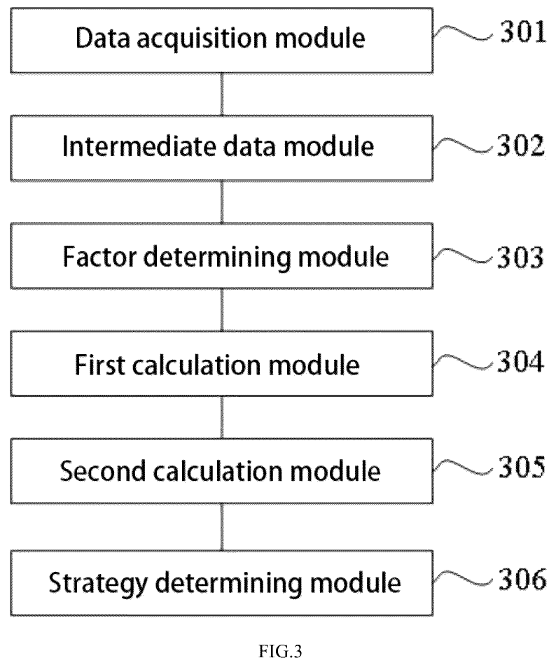

Referring to FIG. 3, FIG. 3 is a schematic structural diagram of a crop carbon footprint evaluation system provided by the present disclosure.

As shown in FIG. 3, a crop carbon footprint evaluation system provided by an embodiment of the present disclosure includes:
a data acquisition module 301, configured to acquire historical data of crops to be evaluated at a production stage and a planting stage;
an intermediate data module 302, configured to determine, based on the historical data, a first carbon emission consumed energy in the planting stage, a second carbon emission consumed energy in the fertilizing stage, and a third carbon emission in the growing stage of the crops to be evaluated per unit planting area;
a factor determining module 303, configured to determine a first adjustment factor and a second adjustment factor of the carbon emission of the crops to be evaluated affected by other factors by predicting the carbon emission characteristic model in combination with the historical data;
a first calculation module 304, configured to acquire a planting area of the crops to be evaluated, and determine a first total carbon emission of seeds of the crops to be evaluated based on the planting area, the first carbon emission, the second carbon emission, the first adjustment factor and the second adjustment factor; the first calculation module is further configured to process the first adjustment factor and the second adjustment factor to obtain a corresponding percentage value, treat the first carbon emission and the second carbon emission according to their degree of effect on the first total carbon emission to obtain treated first carbon emission and treated second carbon emission, determine the first total carbon emission based on the planting area, the treated first carbon emission, the treated second carbon emission, and the percentage value; where the first total carbon emission is represented as:

$$C = ( {E}^{2} + \sqrt{F} ) \times A \times {( 1 + \frac{T}{100} )}^{2} \times {( 1 + \frac{S}{100} )}^{2} ;$$

where C is the first total carbon emission, E is the first carbon emission, F is the second carbon emission, A is the planting area, T is the first adjustment factor, and S is the second adjustment factor;
a second calculation module 305, configured to determine a second total carbon emission after the crops to be evaluated grow, based on the first total carbon emission and the third carbon emission; and
a strategy determining module 306, configured to determine a target strategy for reducing carbon footprint for the crops to be evaluated based on the second total carbon emission.

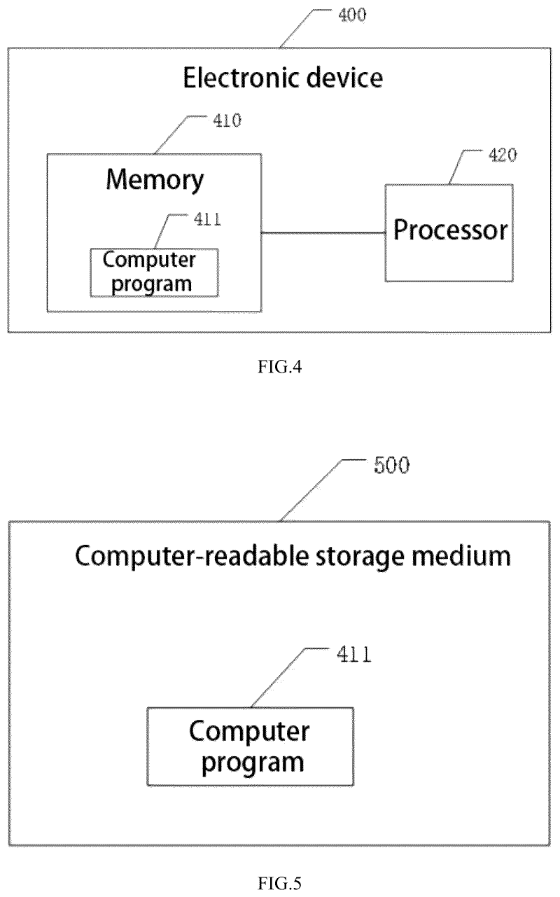

Referring to FIG. 4, FIG. 4 is a schematic diagram of an embodiment of a device provided by an embodiment of the present disclosure. As shown in FIG. 4, an embodiment of the present disclosure provides a device 400, including a memory 410, a processor 420, and a computer program 411 stored in the memory 410 and operable on the processor 420, where when the processor 420 executes the computer program 411, the following steps are implemented:
historical data of crops to be evaluated is acquired at a production stage and a planting stage;
based on the historical data, a first carbon emission consumed energy in the planting stage, a second carbon emission consumed energy in the fertilizing stage, and a third carbon emission in the growing stage of the crops to be evaluated per unit planting area are determined;
a first adjustment factor and a second adjustment factor of the carbon emission of the crops to be evaluated affected by other factors are determined by predicting the carbon emission characteristic model in combination with the historical data;
a planting area of the crops to be evaluated is acquired, and a first total carbon emission of seeds of the crops to be evaluated is determined based on the planting area, the first carbon emission, the second carbon emission, the first adjustment factor and the second adjustment factor, including: the first adjustment factor and the second adjustment factor are processed to obtain a corresponding percentage value; the first carbon emission and the second carbon emission are treated according to their degree of effect on the first total carbon emission to obtain treated first carbon emission and treated second carbon emission; the first total carbon emission is determined based on the planting area, the treated first carbon emission, the treated second carbon emission, and the percentage value; where the first total carbon emission is represented as:

$$C = ( {E}^{2} + \sqrt{F} ) \times A \times {( 1 + \frac{T}{100} )}^{2} \times {( 1 + \frac{S}{100} )}^{2} ;$$

where C is the first total carbon emission, E is the first carbon emission, F is the second carbon emission, A is the planting area, T is the first adjustment factor, and S is the second adjustment factor;
a second total carbon emission after the crops to be evaluated grow is determined based on the first total carbon emission and the third carbon emission; and
a target strategy for reducing carbon footprint for the crops to be evaluated is determined based on the second total carbon emission.

Referring to FIG. 5, FIG. 5 is a schematic diagram of an embodiment of a computer-readable storage medium provided by an embodiment of the present disclosure. As shown in FIG. 5, the present embodiment provides a computer-readable storage medium 500, having a computer program 411 stored therein, and when the computer program 411 is executed by a processor, the following steps are implemented:
historical data of crops to be evaluated is acquired at a production stage and a planting stage;
based on the historical data, a first carbon emission consumed energy in the planting stage, a second carbon emission consumed energy in the fertilizing stage, and a third carbon emission in the growing stage of the crops to be evaluated per unit planting area are determined;
a first adjustment factor and a second adjustment factor of the carbon emission of the crops to be evaluated affected by other factors are determined by predicting the carbon emission characteristic model in combination with the historical data;
a planting area of the crops to be evaluated is acquired, and a first total carbon emission of seeds of the crops to be evaluated is determined based on the planting area, the first carbon emission, the second carbon emission, the first adjustment factor, and the second adjustment factor, including: the first adjustment factor and the second adjustment factor are processed to obtain a corresponding percentage value; the first carbon emission and the second carbon emission are treated according to their degree of effect on the first total carbon emission to obtain treated first carbon emission and treated second carbon emission; the first total carbon emission is determined based on the planting area, the treated first carbon emission, the treated second carbon emission, and the percentage value; where the first total carbon emission is represented as:

$$C = ( {E}^{2} + \sqrt{F} ) \times A \times {( 1 + \frac{T}{100} )}^{2} \times {( 1 + \frac{S}{100} )}^{2} ;$$

where C is the first total carbon emission, E is the first carbon emission, F is the second carbon emission, A is the planting area, T is the first adjustment factor, and S is the second adjustment factor;
a second total carbon emission after the crops to be evaluated grow is determined based on the first total carbon emission and the third carbon emission; and
a target strategy for reducing carbon footprint for the crops to be evaluated is determined based on the second total carbon emission.

It should be noted that in the above-mentioned embodiments, the description of each embodiment has its own emphasis, and parts of one embodiment which are not described in detail may be referred to the description of other embodiments.

It will be understood by a person skilled in the art that embodiments of the present application can be provided as a method, system or computer program product. Accordingly, the present application may take the form of an entirely hardware embodiment, an entirely software embodiment or an embodiment combining software and hardware aspects. Furthermore, the present application can take the form of a computer program product embodied on one or more computer-usable storage media (including, but not limited to, magnetic disk storage, CD-ROM, optical storage, etc.) having computer-usable program code embodied therein.

The present disclosure is described with reference to flow chart illustrations and/or block diagrams of methods, devices (systems), and computer program products according to embodiments of the present disclosure. It will be understood that each flow and/or block of the flow charts and/or block diagrams, and combinations of flows and/or blocks in the flow charts and/or block diagrams, can be implemented by computer program instructions. These computer program instructions may be provided to a processor of a general-purpose computer, a special purpose computer, an embedded computer, or other programmable data processing device to produce a machine, such that the instructions, which execute via the processor of the computer or other programmable data processing device, create a system for implementing the functions specified in the flow chart flow or flows and/or block diagram block or blocks.

These computer program instructions may also be stored in a computer-readable memory that can direct a computer or other programmable data processing device to function in a particular manner, such that the instructions stored in the computer-readable memory produce an article of manufacture including an instruction system which implement the function specified in the flow chart flow or flows and/or block diagram block or blocks.

These computer program instructions may also be loaded onto a computer or other programmable data processing device to cause a series of operational steps to be carried out on the computer or other programmable device to produce a computer implemented process so that the instructions which execute on the computer or other programmable device provide steps for implementing the functions specified in the flow chart flow or flows and/or block diagram block or blocks.

While the preferred embodiments of the present disclosure have been described, additional variations and modifications in those embodiments may occur to a person skilled in the art once they learn of the basic inventive concepts. Therefore, it is intended that the appended claims be interpreted as including the preferred embodiments and all alterations and modifications that fall within the scope of the present disclosure.

It will be apparent to a person skilled in the art that various modifications and variations can be made in the present disclosure without departing from the spirit or scope of the inventions. Thus, if such modifications and variations of the present disclosure fall within the scope of the claims of the present disclosure and their equivalents, the present disclosure is also intended to include such modifications and variations.

1. A crop carbon footprint evaluation and reduction method, comprising:
acquiring historical data of crops to be evaluated at a growing stage and a planting stage;
predicting first carbon emission based on a planting density, a growth cycle, a planting device used, and an energy type of the crops to be evaluated in historical data; predicting second carbon emission based on an amount, number and manner of fertilization of crops to be evaluated in the historical data; and predicting third carbon emission based on the historical data of soil, water resources, pesticide use data of a growing stage of the crops to be evaluated, and soil carbon sequestration emission data of an area where the crops to be evaluated are located;
determining a first adjustment factor and a second adjustment factor of carbon emission of the crops to be evaluated affected by other factors by a machine learning algorithm in combination with the historical data by:
performing feature extraction on the historical data through the machine learning algorithm and obtaining first features related to soil management and pesticide use of the crops to be evaluated, wherein the first features comprise soil management methods, a fertilization amount, an amount of pesticide usage and a use frequency; performing feature extraction on the historical data through the machine learning algorithm and obtaining second features related to transportation of the crops to be evaluated; wherein the second features comprise transportation distances, transportation tools and transportation means; and processing the first features through the machine learning algorithm to output a first adjustment factor, and processing the second features to output a second adjustment factor;
acquiring a planting area of the crops to be evaluated, and determining a first total carbon emission of seeds of the crops to be evaluated based on the planting area, the first carbon emission, the second carbon emission, the first adjustment factor, and the second adjustment factor, comprising: processing the first adjustment factor and the second adjustment factor to obtain a corresponding percentage value; treating the first carbon emission and the second carbon emission according to their degrees of effect on the first total carbon emission to obtain treated first carbon emission and treated second carbon emission; determining the first total carbon emission based on the planting area, the treated first carbon emission, the treated second carbon emission, and a percentage value; wherein the first total carbon emission is represented as:
$$C = ( {E}^{2} + \sqrt{F} ) \times A \times {( 1 + \frac{T}{100} )}^{2} \times {( 1 + \frac{S}{100} )}^{2} ;$$
wherein C is the first total carbon emission, E is the first carbon emission, F is the second carbon emission, A is the planting area, T is the first adjustment factor, and S is the second adjustment factor;
determining a second total carbon emission after the crops to be evaluated grow, based on the first total carbon emission and the third carbon emission; further comprising: acquiring a processed first adjustment factor; treating the third carbon emission according to its degree of effect on the second carbon emission to obtain a treated third carbon emission; determining the second total carbon emission based on the first total carbon emission, the treated first adjustment factor, and the treated third carbon emission; wherein the second total carbon emission is represented as:
$$P = {( C \times {( 1 + \frac{T}{100} )}^{2} )}^{2} + \sqrt{B} \times ( 1 + \frac{T}{100} ) ;$$
wherein P is the second total carbon emission, C is the first total carbon emission, T is the first adjustment factor, and B is the third carbon emission;
determining a target strategy for reducing carbon footprint for the crops to be evaluated based on the second total carbon emission; and
implementing the target strategy, thereby reducing the carbon footprint for the crops.

2. (canceled)

3. (canceled)

4. (canceled)

5. The crop carbon footprint evaluation and reduction method according to claim 1, wherein determining a target strategy for reducing carbon footprint for the crops to be evaluated based on the second total carbon emission comprises:
determining carbon emission constituent data for each link of the crops to be evaluated based on the second total carbon emission;
determining a target emission reduction for the carbon footprint of the crops to be evaluated based on the carbon emission constituent data; and
specifying a target strategy based on the target emission reduction.

6. The crop carbon footprint evaluation and reduction method according to claim 1, wherein acquiring historical data of the crops to be evaluated at a production stage and a planting stage comprises:
determining a data source of the historical data, wherein the data source comprise planting record reports and environmental monitoring reports of the planting area of the crops to be evaluated;
acquiring first historical data of the planting stage from the data source; wherein the first historical data comprises a planting density, an area, a growth cycle data, first energy consumption data, greenhouse gas emission data, and soil organic carbon content data of the crops to be evaluated; and
acquiring second historical data of the growing stage from the data source; the second historical data comprises fertilization data, second energy consumption data, and water resources, soil, and pesticide use data.

7. (canceled)

8. (canceled)

9. (canceled)

10. The crop carbon footprint evaluation and reduction method according to claim 1, wherein the target strategy comprises:
increasing use of organic fertilizer, reducing use of fertilizer, optimizing a planting device and an irrigation system to reduce energy consumption, and implementing precise agricultural management to reduce pesticide usage and greenhouse gas emissions;
adopting precise fertilization technology to reduce the fertilization amount and frequency, increasing the use of organic fertilizer, reducing the emission of active nitrogen, improving soil quality and promoting soil carbon sequestration;
using an energy-saving irrigation system to reduce water resources consumption and energy consumption and reduce methane emissions, and increasing the use of agro-ecological environment-friendly technology to reduce pesticide usage and soil erosion; or
optimizing transportation routes and means of transport to reduce transportation distances and energy consumption and increasing use of low-carbon transportation modes.

11. The crop carbon footprint evaluation and reduction method according to claim 1, wherein the target strategy comprises, in a planting stage, increasing water-saving irrigation technology, and reducing fertilizer use.

12. The crop carbon footprint evaluation and reduction method according to claim 1, wherein the target strategy comprises replacing non-renewable energy with renewable energy in a growing stage.

13. The crop carbon footprint evaluation and reduction method according to claim 1, wherein the target strategy comprises modifying transportation routes and means of transport during a transportation stage to reduce energy consumption and carbon emission during transportation.

14. The crop carbon footprint evaluation and reduction method according to claim 1, wherein the target strategy comprises reducing use of resources or consumption of energy.
